(19) United States
(12) Patent Application Publication
(10) Pub. No.: US 2025/0167415 A1
(43) Pub. Date: May 22, 2025

(54) ENHANCED BROADBAND RING RESONATOR FOR IMPROVED SPECTRAL SUPPRESSION

(71) Applicant: Raytheon Company, Waltham, MA (US)

(72) Inventors: Cory William Cathrea, Tucson, AZ (US); Ryan D. Dewitt, Tucson, AZ (US)

(73) Assignee: Raytheon Company, Waltham, MA (US)

(21) Appl. No.: 18/512,152

(22) Filed: Nov. 17, 2023

(51) Int. Cl. H01P 1/203

(52) U.S. Cl. CPC H01P 1/20381; H01P 1/20309

(57) ABSTRACT

A broadband ring resonator including a substrate, a conductive trace on the substrate comprising a first end and a second end, wherein the conductive trace encloses an interior region except for a gap between the first end and the second end, and at least one radial stub integrated into the conductive trace and a method of enhancing a bandwidth of a split ring resonator including acquiring a substrate, forming a conductive trace on the substrate comprising a first end and a second end, wherein the conductive trace encloses an interior region except for a gap between the first end and the second end, and integrating at least one radial stub into the conductive trace.

### BACKGROUND

Active radio frequency (RF) circuits require power and/or digital connections that allow for unwanted transmission of RF signals through circuit card assemblies (CCAs). Power traces internal to a printed circuit board (PCB) are often surrounded by power planes that may create parallel plate waveguide modes that propagate noise throughout the power planes. This may not be an issue with proper via stitching and grounding, but it is ever present in designs unable to stitch vias due to route density. Stitching vias are a periodic array of vias that are generally grounded across a PCB stackup. In this way, stitching vias make connections between ground planes on multiple layers. Similarly, single-ended and differential traces are ideal 50 Ohms (Ω) and 100Ω that RF would have little issue propagating on.

Active devices typically have inherent isolation between power traces and other signals running through a device. However, once noise reaches digital and signal traces a system may not function properly. Typically, a decoupling capacitor is placed on a digital trace to suppress noise coming from power traces connected to active devices. However, at high frequencies (e.g., above 20 GHz) it is not always possible to add more lumped elements to increase isolation. There also may not always be room on a surface of a PCB to add an extra lumped element necessary to provide extra isolation.

Some designs implement resonant structures that provide greater spur suppression above the 20 GHz limit of most lumped element filters. The resonant structures were typically integrated into internal copper layers of a CCA's PCB with the intention of using space that was otherwise left unused. Resonant structures have been used on RF traces.

Lumped element filters are a common method for noise suppression on active devices below 20 GHz. Lumped element filters may not provide adequate spectral suppression for digital and power connections. Power supply connections may benefit significantly from filtering at frequencies greater than 20 GHz. Conical inductors may have SRFs above 35 GHz but may be negatively impacted by shock and vibration events. Component values for a useful lumped element filter may be limited. Additional components implemented on a surface of a PCB may take up valuable layout space.

### SUMMARY

In accordance with the concepts described herein, exemplary devices and methods provide an enhanced broadband ring resonator (EBRR) for improved noise suppression on a power supply line and a digital signal line on a RF CCA.

In accordance with the concepts described herein, exemplary devices and methods provide a split ring resonator with an embedded structure for improved spectral suppression on a power supply line and a digital signal line on a RF CCA.

In accordance with the concepts described herein, exemplary devices and methods provide a split ring resonator with at least one radial stub to enable the split ring resonator to have a plurality of resonant frequencies.

In accordance with the concepts described herein, exemplary devices and methods provide a split ring resonator that includes a plurality of individual resonant structures to realize a band-stop filter.

### DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principles of the concepts described herein. Like reference numerals designate corresponding parts throughout the different views. Furthermore, embodiments are illustrated by way of example and not limitation in the figures, in which:

FIG. 1 is an illustration of a prior art circular split ring resonator;

FIG. 2 is an illustration of a prior art rectangular split ring resonator;

FIG. 3 is an illustration of an exemplary EBRR with one radial stub according to the present disclosure;

FIG. 4 is an illustration of an exemplary EBRR with two radial stubs according to the present disclosure;

FIG. 5 is an illustration of an exemplary EBRR with three radial stubs according to the present disclosure;

FIG. 6 is an illustration of two exemplary cascaded EBRRs of different sizes, each with three radial stubs according to the present disclosure; and

FIG. 7 is a flowchart of an exemplary method of fabricating an exemplary EBRR with at least one embedded radial stub according to the present disclosure.

### DETAILED DESCRIPTION

Conventional devices that utilize resonant structures to cover small bandwidths of rejection may not be useful in RF PCBs. A ring resonator may be used to determine a dielectric constant of a material. A variation of a ring resonator includes a split in a section of the ring resonator to create two open stubs on the ring resonator (commonly referred to as a split ring resonator). Conventional split ring resonators might not be placed in circuits to filter noise. Ring resonators have been cascaded to realize wide bandwidth noise rejection. Conventional ring resonators may take up a significant amount of space on a PCB.

An EBRR of the present disclosure may be scaled in size to change the EBRR's resonant frequency to meet a requirement of an RF system. An EBRR on the present disclosure may include a plurality of resonant structures (e.g., radial stubs) to provide noise suppression. An EBRR of the present disclosure may provide wide-band noise rejection at high frequencies that conventional lumped element filters may not.

An EBRR of the present disclosure may increase a bandwidth of a high Q ring resonator to create a filter that takes up less space on a PCB than a conventional ring resonator. A Q factor, also known as a quality factor, is a measure of damping of a resonant circuit or system. Q is a dimensionless parameter that indicates energy loss of a system as the system oscillates at its resonant frequency. The higher the value of Q, the narrower and the sharper is the resonance. Thus, an electronic circuit with a high Q value would respond to a very narrow range of frequencies.

An EBRR of the present disclosure may be placed on an internal layer or a surface layer of a PCB. An EBRR of the present disclosure does not require an input impedance to match an output impedance. An EBRR of the present disclosure may be constructed of a metal (e.g., copper) or a conductive material using standard manufacturing processes. An EBRR of the present disclosure may be manufactured on high dielectric constant materials, which may enable an EBRR to substitute for a lumped element on a CCA.

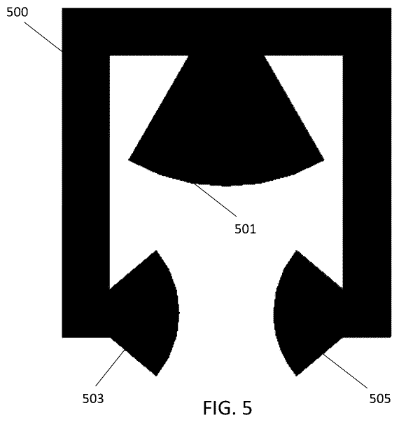

At low frequencies (e.g., approximately 4 Giga Hertz (GHz)), an EBRR with a dual fan radial stub gap (e.g., the EBRR as illustrated in FIG. 5 and described below in greater detail) of the present disclosure may allow a signal to pass through the EBRR without issue (e.g., without attenuation). At a resonant frequency of an EBRR of the present disclosure (e.g., approximately 24 GHz), a signal may radiate across a dual fan radial stub gap of an EBRR (e.g., the EBRR as illustrated in FIG. 5 and described below in greater detail).

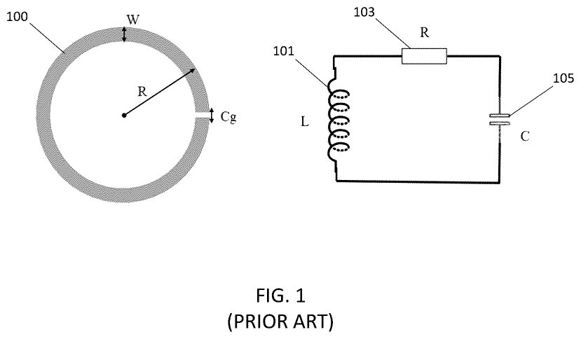

FIG. 1 is an illustration of a prior art circular split ring resonator 100 and an equivalent circuit of the circular split ring resonator 100. The circular split ring resonator 100 of radius R comprises a circular conductive trace of width W with a gap therein that establishes a capacitance Cg between two ends of the conductive trace that form the gap. The equivalent circuit of the circular split ring resonator 100 comprises an inductor L 101, a resistor R 103, and a capacitor C 105 connected in series.

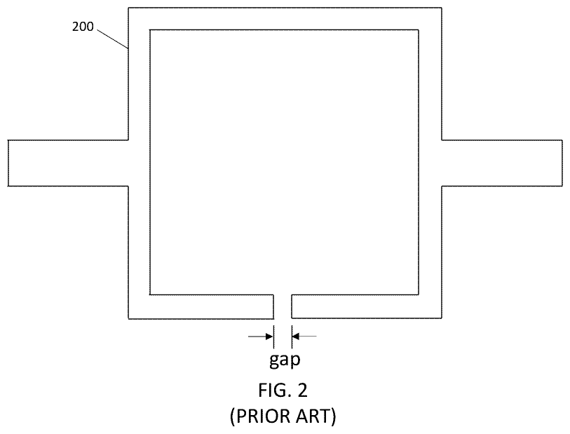

FIG. 2 is an illustration of a prior art rectangular split ring resonator 200 comprising a rectangular conductive trace having a width with a gap therein that functions similarly as the circular split ring resonator 100 of FIG. 1.

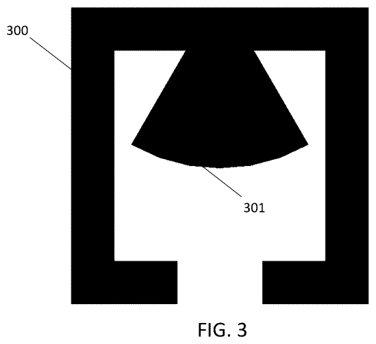

FIG. 3 is an illustration of an exemplary EBRR 300 with one radial stub 301 according to the present disclosure. The EBRR 300 comprises a rectangular conductive trace with a gap therein in a bottom portion of the rectangular conductive trace and the radial stub 301 connected to a top portion and an interior portion of the rectangular conductive trace. However, the present disclosure is not limited thereto. The rectangular conductive trace may be circular, polygonal, etc. with a gap therein and with the radial stub 301 attached to the circular, rectangular, polygonal, etc. conductive trace. The radial stub 301 may be located on any portion of the rectangular, circular, polygonal, etc. conductive trace and on either an interior portion or an exterior portion of the rectangular, circular, polygonal etc. conductive trace.

The radial stub 301 may be shaped as a wedge of a pie with sharp corners and the center point of the pie wedge connected to the rectangular conductive trace of the EBRR 300 as illustrated in FIG. 3. However, the present disclosure is not limited thereto. The radial stub 301 may be shaped as a pie wedge, a circle, a square, a rectangle, a polygon, etc., with any one side or junction between two sides of the shape connected to the EBRR 300.

The rectangular conductive trace, and any other shape of conductive trace, of the EBRR 300 and the radial stub 301 may each be fabricated of a conductive material (e.g., a metal, a material infused with a conductive material, etc.). The metal may be copper, aluminum, iron, and so on.

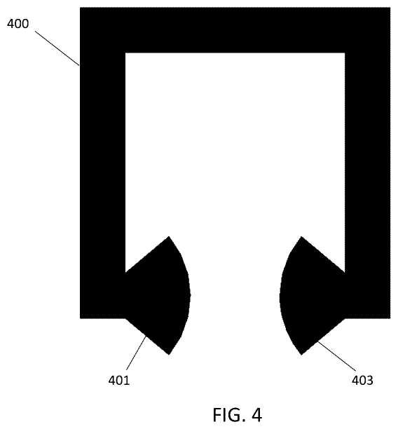

FIG. 4 is an illustration of an exemplary EBRR 400 with a first radial stub 401 and a second radial stub 403 according to the present disclosure. The EBRR 400 comprises a rectangular conductive trace with a gap therein in a bottom portion of the rectangular conductive trace and the first radial stub 401 and the second radial stub 403 connected to one of two sides of the gap in the rectangular conductive trace, respectively. However, the present disclosure is not limited thereto. The rectangular conductive trace may be circular, polygonal, etc. with a gap therein and with the first radial stub 401 and the second radial stub 403 connected to the rectangular, circular, polygonal, etc. conductive trace. The first radial stub 401 and the second radial stub 403 may be located on any portion of the rectangular, circular, polygonal, etc. conductive trace and on either an interior portion or an exterior portion of the rectangular, circular, polygonal etc. conductive trace. The first radial stub 401 and the second radial stub 403 may be the same size or different sizes.

The first radial stub 401 and the second radial stub 403 may each be shaped as a wedge of a pie with sharp corners and the center points of the pie wedge connected to one of two sides of the gap in the rectangular conductive trace, respectively, of the EBRR 400 as illustrated in FIG. 4. However, the present disclosure is not limited thereto. The first radial stub 401 and the second radial stub 403 may be shaped as a pie wedge, a circle, a square, a rectangle, a polygon, etc., with any one side or junction between two sides of the shape connected to the EBRR 400, where the first radial stub 401 and the second radial stub 403 may be the same shape or different shapes.

The rectangular conductive trace, and any other shape of conductive trace, of the EBRR 400 and the first radial stub 401 and the second radial stub 403 may each be fabricated of a conductive material (e.g., a metal, a material infused with a conductive material, etc.). The metal may be copper, aluminum, iron, and so on.

FIG. 5 is an illustration of an exemplary EBRR 500 with a first radial stub 501, a second radial stub 503, and a third radial stub 505 according to the present disclosure. The EBRR 500 comprises a rectangular conductive trace with a gap therein in a bottom portion of the rectangular conductive trace, where the first radial stub 501 is connected to a top portion and an interior portion of the rectangular conductive trace, and where the second radial stub 503 and the third radial stub 505 are connected to one of two sides of the gap in the rectangular conductive trace, respectively. However, the present disclosure is not limited thereto. The rectangular conductive trace may be circular, polygonal, etc. with a gap therein and with the first radial stub 501, the second radial stub 503, and the third radial stub 505 connected to the rectangular, circular, polygonal, etc. conductive trace. The first radial stub 501, the second radial stub 503, and the third radial stub 505 may be located on any portion of the rectangular, circular, polygonal, etc. conductive trace and on either an interior portion or an exterior portion of the rectangular, circular, polygonal etc. conductive trace. FIG. 5 illustrates the second radial stub 503 and the third radial stub 505 being the same size and the first radial stub 501 having a size greater than the second radial stub 503 and the third radial stub 505. However, the present disclosure is not limited thereto. The first radial stub 501, the second radial stub 503, and the third radial stub 505 may be the same size or different sizes from each other in any combination and permutation.

The first radial stub 501, the second radial stub 503, and the third radial stub 505 may each be shaped as a wedge of a pie with sharp corners and the center points of the pie wedge connected to the rectangular conductive trace of the EBRR 500 as illustrated in FIG. 5. However, the present disclosure is not limited thereto. The first radial stub 501, the second radial stub 503, and the third radial stub 505 may be shaped as a pie wedge, a circle, a square, a rectangle, a polygon, etc., with any one side or junction between two sides of the shape connected to the EBRR 500, where the first radial stub 501, the second radial stub 503, and the third radial stub 505 may be the same shape or different shapes from each other in any combination or permutation.

The rectangular conductive trace, and any other shape of conductive trace, of the EBRR 500 and the first radial stub 501, the second radial stub 503, and the third radial stub 505 may each be fabricated of a conductive material (e.g., a metal, a material infused with a conductive material, etc.). The metal may be copper, aluminum, iron, and so on.

The EBRR 500 with the first radial stub 501, the second radial stub 503, and the third radial stub 505 each facing the interior of the rectangular conductive trace allows the EBRR 500 to have several resonant frequencies. A conventional split ring resonator, as illustrated in FIGS. 1 and 2, is a high Q resonator with a narrow bandwidth of noise rejection. The EBRR 500 has a wider bandwidth of noise rejection as compared to a conventional split ring resonator due to the first radial stub 501, the second radial stub 503, and the third radial stub 505. The first radial stub 501, the second radial stub 503, and the third radial stub 505 point inward in the interior of the rectangular conductive trace, which would, otherwise, be unoccupied. However, the present disclosure is not limited thereto. The first radial stub 501, the second radial stub 503, and the third radial stub 505 may each be connected to an exterior side of the rectangular conductive trace and point outward and away from the EBRR 500. The first radial stub 501, the second radial stub 503 each have a resonant frequency so that the EBRR 500 has a wider bandwidth of noise rejection as compared to a conventional split ring resonator.

When utilizing resonant structures in PCBs, the structures are often utilized as separate and successive structures rather than a single integrated structure as the EBRRs of the present disclosure. The EBRRs of the present disclosure each utilize a plurality of resonant structures to realize a band-stop filter.

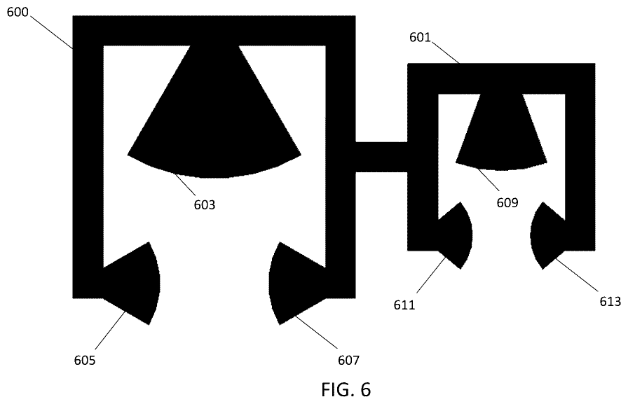

FIG. 6 is an illustration of an exemplary first EBRR 600 and an exemplary second EBRR 601 of different sizes cascaded (e.g., connected in series) according to the present disclosure. The first EBRR 600 includes a first radial stub 603, a second radial stub 605, and a third radial stub 607. The second EBRR 601 includes a fourth radial stub 609, a fifth radial stub 611, and a sixth radial stub 613. Each of the EBRR 600 and the EBRR 601 comprises a rectangular conductive trace with a gap therein in a bottom portion of the rectangular conductive trace. In the first EBRR 600, the first radial stub 603 is connected to a top portion and an interior portion of the rectangular conductive trace of the first EBRR 600, and the second radial stub 605 and the third radial stub 607 are connected to one of two sides of the gap in the rectangular conductive trace of the first EBRR 600, respectively. In the second EBRR 601, the fourth radial stub 609 is connected to a top portion and an interior portion of the rectangular conductive trace of the second EBRR 601, and the fifth radial stub 611 and the sixth radial stub 613 are connected to one of two sides of the gap in the rectangular conductive trace of the second EBRR 601, respectively. However, the present disclosure is not limited thereto. The rectangular conductive traces may be circular, polygonal, etc. with a gap therein and with the first radial stub 603, the second radial stub 605, the third radial stub 607, the fourth radial stub 609, the fifth radial stub 611, and the sixth radial stub 613 connected to the corresponding rectangular, circular, polygonal, etc. conductive trace, respectively. The first radial stub 603, the second radial stub 605, the third radial stub 607, the fourth radial stub 609, the fifth radial stub 611, and the sixth radial stub 613 may each be located on any portion of the corresponding rectangular, circular, polygonal, etc. conductive trace and on either an interior portion or an exterior portion of the corresponding rectangular, circular, polygonal etc. conductive trace. FIG. 6 illustrates the second radial stub 605 and the third radial stub 607 being the same size and the first radial stub 603 having a size greater than the second radial stub 605 and the third radial stub 607. However, the present disclosure is not limited thereto. The first radial stub 603, the second radial stub 605, and the third radial stub 607 may be the same size or different sizes from each other in any combination and permutation. In addition, FIG. 6 illustrates the fifth radial stub 611 and the sixth radial stub 613 being the same size and the fourth radial stub 609 having a size greater than the fifth radial stub 611 and the sixth radial stub 613. However, the present disclosure is not limited thereto. The fourth radial stub 609, the fifth radial stub 611, and the sixth radial stub 613 may be the same size or different sizes from each other in any combination and permutation.

The first radial stub 603, the second radial stub 605, the third radial stub 607, the fourth radial stub 609, the fifth radial stub 611, and the sixth radial stub 613 may each be shaped as a wedge of a pie with sharp corners and the center points of the pie wedge connected to the corresponding rectangular conductive trace of the first EBRR 600 and the second EBRR 601, respectively, as illustrated in FIG. 6. However, the present disclosure is not limited thereto. The first radial stub 603, the second radial stub 605, the third radial stub 607, the fourth radial stub 609, the fifth radial stub 611, and the sixth radial stub 613 may be shaped as a pie wedge, a circle, a square, a rectangle, a polygon, etc., with any one side or junction between two sides of the shape connected to the first EBRR 600 and the second EBRR 601, respectively, where the first radial stub 603, the second radial stub 605, the third radial stub 607, the fourth radial stub 609, the fifth radial stub 611, and the sixth radial stub 613 may be the same shape or different shapes from each other, respectively, in any combination or permutation.

The respective rectangular conductive traces, and any other shape of conductive traces, of the first EBRR 600 and the second EBRR 601, and the first radial stub 603, the second radial stub 605, the third radial stub 607, the fourth radial stub 609, the fifth radial stub 611, and the sixth radial stub 613 may each be fabricated of a conductive material (e.g., a metal, a material infused with a conductive material, etc.). The metal may be copper, aluminum, iron, and so on.

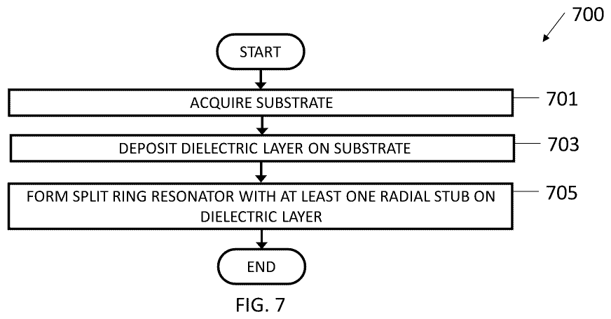

FIG. 7 is a flowchart of an exemplary method 700 of enhancing a bandwidth of a ring resonator. Step 701 of the method 800 comprises acquiring a substrate. The substrate comprises a printed circuit board, a semiconductor, a ceramic, or a glass. Step 703 of the method 700 comprises depositing a dielectric layer on the substrate. Step 705 comprises forming a split ring resonator with at least one radial stub on the dielectric layer. For technologies that deposit a metallization onto a substrate, an entire EBRR may be formed at one time. An EBRR may either be subtractive (e.g., etching a metal) or additively (e.g., depositing a metal) manufactured based on the substrate being, for example, cladded with metal or not cladded with metal.

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable sub combination. Other embodiments not specifically described herein are also within the scope of the following claims.

Various embodiments of the concepts, systems, devices, structures and techniques sought to be protected are described herein with reference to the related drawings. Alternative embodiments can be devised without departing from the scope of the concepts, systems, devices, structures and techniques described herein.

It is noted that various connections and positional relationships (e.g., over, below, adjacent, etc.) are set forth between elements in the above description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “at least one” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description herein, terms such as “upper,” “lower,” “right,” “left,” “vertical,” “horizontal, “top,” “bottom,” (to name but a few examples) and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements. Such terms are sometimes referred to as directional or positional terms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A broadband ring resonator, comprising:
a substrate;
a conductive trace on the substrate comprising a first end and a second end, wherein the conductive trace encloses an interior region except for a gap between the first end and the second end; and
at least one radial stub integrated into the conductive trace.

2. The broadband ring resonator of claim 1, wherein the conductive trace comprises a shape comprising a circle, a square, a rectangle, or a polygon.

3. The broadband ring resonator of claim 1, wherein the conductive trace and the at least one radial stub each comprises a metal or a non-metallic material infused with conductive material to enable the non-metallic material to be conductive.

4. The broadband ring resonator of claim 3, wherein the metal comprises copper, aluminum, or iron and the substrate comprises a printed circuit board, a semiconductor, a ceramic, or a glass.

5. The broadband ring resonator of claim 1, wherein the at least one radial stub comprises one radial stub integrated into the conductive trace at any location along the conductive trace with the interior enclosed by the conductive trace or at any location along the conductive trace exterior to the conductive trace.

6. The broadband ring resonator of claim 1, wherein the at least one radial stub comprises a first radial stub integrated into the conductive trace at the first end of the conductive trace and a second radial stub integrated into the conductive trace at the second end of the conductive trace.

7. The broadband ring resonator of claim 1, wherein the at least one radial stub comprises a first radial stub integrated into the conductive trace at any location along the conductive trace with the interior enclosed by the conductive trace or at any location along the conductive trace exterior to the conductive trace, a second radial stub integrated into the conductive trace at the first end of the conductive trace, and a third radial stub integrated into the conductive trace at the second end of the conductive trace.

8. The broadband ring resonator of claim 1, wherein the at least one radial stub comprises pointed edges or rounded edges in any combination or permutation.

9. The broadband ring resonator of claim 1, wherein the at least one radial stub comprises sizes that are identical or different in any combination or permutation.

10. The broadband ring resonator of claim 1, wherein the at least one radial stub is integrated into the conductive trace by any side or edge of the at least one radial stub.

11. A method of enhancing a bandwidth of a split ring resonator, comprising:
acquiring a substrate;
depositing a dielectric layer on the substrate; and
forming a conductive trace on the dielectric layer comprising a first end and a second end and at least one radial stub, wherein the conductive trace encloses an interior region except for a gap between the first end and the second end.

12. The method of claim 11, wherein the conductive trace comprises a shape comprising a circle, a square, a rectangle, or a polygon.

13. The method of claim 11, wherein the conductive trace and the at least one radial stub each comprises a metal or a non-metallic material infused with conductive material to enable the non-metallic material to be conductive.

14. The method of claim 13, wherein the metal comprises copper, aluminum, or iron and the substrate comprises a printed circuit board, a semiconductor, a ceramic, or a glass.

15. The method of claim 11, wherein the at least one radial stub comprises one radial stub integrated into the conductive trace at any location along the conductive trace with the interior enclosed by the conductive trace or at any location along the conductive trace exterior to the conductive trace.

16. The method of claim 11, wherein the at least one radial stub comprises a first radial stub integrated into the conductive trace at the first end of the conductive trace and a second radial stub integrated into the conductive trace at the second end of the conductive trace.

17. The method of claim 11, wherein the at least one radial stub comprises a first radial stub integrated into the conductive trace at any location along the conductive trace with the interior enclosed by the conductive trace or at any location along the conductive trace exterior to the conductive trace, a second radial stub integrated into the conductive trace at the first end of the conductive trace, and a third radial stub integrated into the conductive trace at the second end of the conductive trace.

18. The method of claim 11, wherein the at least one radial stub comprises pointed edges or rounded edges in any combination or permutation.

19. The method of claim 11, wherein the at least one radial stub comprises sizes that are identical or different in any combination or permutation.

20. The method of claim 11, wherein the at least one radial stub is integrated into the conductive trace by any side or edge of the at least one radial stub.
